(19) United States
(12) Patent Application Publication
(10) Pub. No.: US 2004/0202249 A1
(43) Pub. Date: Oct. 14, 2004

(54) Real-time MPEG video encoding method of maintaining synchronization between video and audio

(75) Inventors: Chien-Shun Lo, Hsinchu (TW); Wei-Chuan Hsiao, Hsinchu (TW); Shih-Chin Hsu, Hsinchu (TW); Teng-Chou Chang, Hsinchu (TW); Wei-Jen Huang, Hsinchu (TW)

Correspondence Address: LAW OFFICES OF DAVID PAI, 1001 FOURTH AVENUE, SUITE 3200, SEATTLE, WA, 98154, US

(73) Assignee: NewSoft Technology Corporation, Taipei (TW)

(21) Appl. No.: 10/408,555

(22) Filed: Apr. 8, 2003

(51) Int. Cl. H04N 7/12

(52) U.S. Cl. 375/240.16; 375/240.12; 375/240.03; 375/240.18; 375/240.2

(57) ABSTRACT

When a real-time MPEG video encoding is performed, null frames are used to compensate lost frames. Or, when a performance of the real-time MPEG video encoding is insufficient, the encoding is performed in accordance with a predetermined frame-type output sequence, in which the null frames are uniformly distributed in the predetermined frame-type output sequence. The null frames are encoded by transforming a null predictive frame with a pixel value of 0 into a discrete cosine transform coefficient through a discrete cosine transform algorithm. The discrete cosine transform coefficient is then transformed into a quantized discrete cosine transform coefficient by quantization. The quantized discrete cosine transform coefficient is then encoded with a null motion vector of (0,0) by variable length coding.

### BACKGROUND OF THE INVENTION

1. Field of the Invention

This invention relates to a video encoding method. More particularly, this invention relates to a real-time MPEG (Motion Picture Experts Group) video encoding method of maintaining synchronization between video and audio.

2. Description of the Related Art

Video compact discs (VCDs) and digital versatile discs (DVDs) are both small in size with excellent data storage. At the same time, a normal user can easily produce and edit a personalized VCD or DVD for giving to relatives and friends as a gift. The characteristics of the DVDs, such as a high picture quality and a large storage capacity, can even be used for immediate recording of television programs. Because of the advantages brought by the digital video and audio technology, the VCDs and DVDs have gradually taken over the market place of conventional videotapes, and have won wide acceptance among the people.

In the specifications of the VCDs and DVDs, MPEG 1 and MPEG 2 are used respectively as the primary formats for video encoding to store videos. For National Television System Committee (NTSC), which is used in North America and Japan, the image resolution for the VCD is 352×240 pixels, the number of frames played per second is 29.97, and the uncompressed data is up to 58 Mbps. For the DVD, the image resolution is 720×480 pixels, the number of frames played per second is 29.97, and the uncompressed data is up to 237 Mbps. For Phase Alternate Lines (PAL) on the other hand, which is used in most European countries and Australia, the image resolution for the VCD is 352×288 pixels, the number of frames played per second is 25, and the uncompressed data is also up to 58 Mbps. For the DVD, the image resolution is 720×576 pixels, the number of frames played is 25, and the uncompressed data is also up to 237 Mbps. With such a big amount of data, how to perform real-time encoding compression is a major challenge today.

Hereinafter, the principle of MPEG 1 and MPEG 2 video encoding is briefly explained. Primarily speaking, a sequential video coding is divided into two parts. The first one is called “intra-coding” for generating an intra picture (I picture), which is a compression encoding method for a single image using discrete cosine transform (DCT) algorithm. Therefore, the I picture can be transformed to a static frame without reference to forward or backward frames, and require the biggest amount of data. The second part is called “inter-coding,” which is a method for predicting reconstruction frames by using the adjacent frames to predict the current frame. The method can generate a predicted picture (P picture) or a bi-directional predicted picture (B picture). The difference between the P and B pictures is that the P picture uses only forward prediction. That is, only the forward frame is referred for reconstructing the P picture. On the other hand, the reconstruction of the B picture uses both of the forward and backward frames or an average of the two, and therefore has the highest efficiency for encoding. However, the B picture itself cannot be used for other prediction encoding.

For example, a video regarding a ball falling from the top of a building is recorded in a format of MPEG. First, the DCT technique is employed to encode a first I picture. If the P pictures are generated in such a manner that a forward-predicted distance is 1, the reconstruction of the next P picture will use motion estimation and compensation technique with reference to the previous I picture. For instance, assume the first I picture is a static frame showing the ball is at the top of the building. Because the building is a static object, the building in the second frame can refer to the building in the previous I picture. As to the falling ball, the motion estimation technique can be utilized to calculate motion vectors and motion compensation with reference to the previous I picture, for reconstructing a second P picture. Likewise, a third P picture is reconstructed with reference to the second P picture. Therefore, the P pictures can be reconstructed by recording only the differences from the previous frame, thereby dramatically reducing the required amount of data to achieve compression.

Besides, as shown in FIG. 1, it is necessary to re-establish another I picture after a specified number of P pictures come behind the first I picture, in order to maintain the quality of the video. Only then can user play a video starting from any part of the video without the need to play sequentially starting from the first I picture. If the two I pictures are too far apart, that is, much more P pictures are present between the two I pictures, the quality of the image will be deteriorated. On the other hand, if the two I pictures are too close, the use of the compression technique to reduce the amount of data is less effective because the I picture is a wholeness of a static frame and holds a considerably large amount of data. Frames starting from one I picture and ending before next I picture is called a group of pictures (GOP). The encoding rule regarding how many frames to be contained in a GOP may be set in accordance with practical demands.

However, when a real-time encoding compression is performed by using the above-mentioned MPEG video encoding method, the video and audio may not be kept synchronous. The main reason is that the MPEG video encoder cannot keep up with the speed required for the real-time encoding compression, resulting in an insufficient amount of frames. For instance, in accordance with NTSC, there should be 30 frames played in a second for inputting a video of 1 second in length. If the MPEG video encoder encodes only 15 frames per second, the encoded MPEG file will contain only 15 frames. When the video is played, the MPEG file with 15 frames will be played in 0.5 second but the voice keeps playing for 1 second, resulting in a synchronization failure that the video is finished 0.5 seconds earlier than the audio. Besides, if the source video has an insufficient number of frames per second, the output of the video and audio of the encoded MPEG file will not be synchronous even when the encoding speed of the MPEG video encoder meets the requirement. To sum up, it is a major challenge to ensure a synchronous output of the video and audio after the MPEG encoding in such circumstances that the speed of the MPEG video encoder is insufficient for the real-time MPEG video encoding or the source video has an insufficient number of frames per second.

### SUMMARY OF THE INVENTION

In view of the above-mentioned problems, an object of the invention is to provide a real-time MPEG video encoding method of maintaining synchronization between video and audio, which is capable of ensuring a synchronous output of the video and audio after the MPEG encoding when a speed of an MPEG video encoder is insufficient for a real-time MPEG video encoding.

Another object of the invention is to provide a real-time MPEG video encoding method of maintaining synchronization between video and audio, which is capable of ensuring a synchronous output of the video and audio after the MPEG encoding when the source video has an insufficient number of frames per second.

In order to achieve the aforementioned objects, a real-time MPEG video encoding method of maintaining synchronization between video and audio according to the present invention comprises a frame checking procedure, a frame compensating procedure, and a frame encoding procedure. The frame checking procedure checks if any frames are lost. The frame compensating procedure uses some null frames to compensate lost frames if any frames are lost. The frame encoding procedure uses a standard MPEG video encoding procedure to encode a received frame and output an encoded frame. The encoding method for the null frames encodes a predicted frame with a pixel value of 0. When the encoding of variable length coding (VLC) is performed, the received motion vector is (0,0). During the process of MPEG video encoding, because the step of motion estimation is omitted for null frames and the calculation for transformation and quantization of discrete cosine is faster, the speed for encoding null frames is considerably faster than those for the I, P and B pictures, thereby compensating the lost frames immediately.

Another real-time MPEG video encoding method of maintaining synchronization between video and audio of the invention comprises a system performance checking procedure, a frame-type output sequence selecting procedure, and a frame encoding procedure. The system performance checking procedure estimates a system performance for MPEG video encoding and predicts a number of frames that can be encoded per second by the system. The frame-type output sequence selecting procedure selects a frame-type output sequence by checking the number of frames that can be encoded per second with reference to a frame-type output sequence table. The frame-type output sequence table is a predefined in such a content including frame-type output sequences of frames in each GOP. The frame-type comprises the I picture, the P picture, and the null frame. The frame encoding procedure performs MPEG video encoding on the received frames in sequence according to the selected frame-type output sequence.

According to the real-time MPEG video encoding method of maintaining synchronization between video and audio of the invention, because the null-frame encoding speed is faster, it can immediately compensate the lost frames or frames that cannot be encoded and output in time due to insufficient system performance. A sufficient number of frames for the encoded MPEG file are ensured for maintaining synchronization between video and audio.

### BRIEF DESCRIPTION OF THE DRAWINGS

The above-mentioned and other objects, features, and advantages of the present invention will become apparent with reference to the following descriptions and accompanying drawings, wherein:

FIG. 1 is a schematic diagram of a GOP consisting of frame-type output sequences output by a conventional real-time MPEG video encoding method;

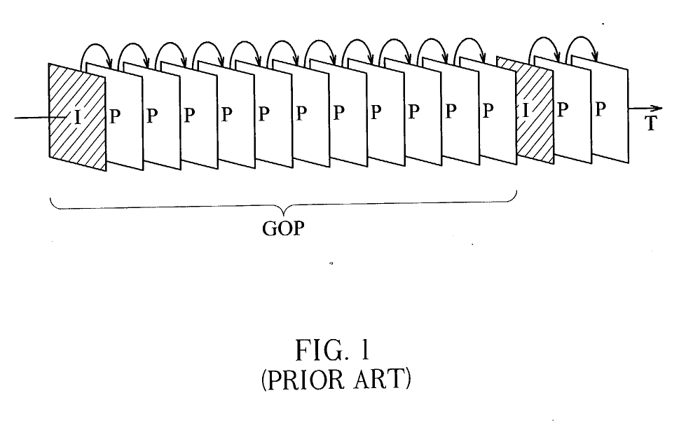

FIG. 2a is a flow diagram illustrating a real-time MPEG video encoding method of maintaining synchronization between video and audio in one embodiment of the invention;

FIG. 2b is a flow diagram showing a simplified process of the real-time MPEG video encoding method of maintaining synchronization between video and audio of FIG. 2a;

FIG. 3 is a flow diagram showing a null-frame encoding method of FIG. 2a;

FIG. 4 is a flow diagram showing a real-time MPEG video encoding method of maintaining synchronization between video and audio in another embodiment of the invention; and

FIG. 5 is a frame-type output sequence table showing frame-type output sequences of GOPs corresponding to numbers of frames that can be encoded per second.

### DETAILED DESCRIPTION OF THE PREFERRED EMBODIMENTS

A real-time MPEG video encoding method of maintaining synchronization between video and audio is explained in detail by descriptions of embodiments with reference to relevant drawings. In the accompanying drawings, similar elements will be denoted with similar reference symbols.

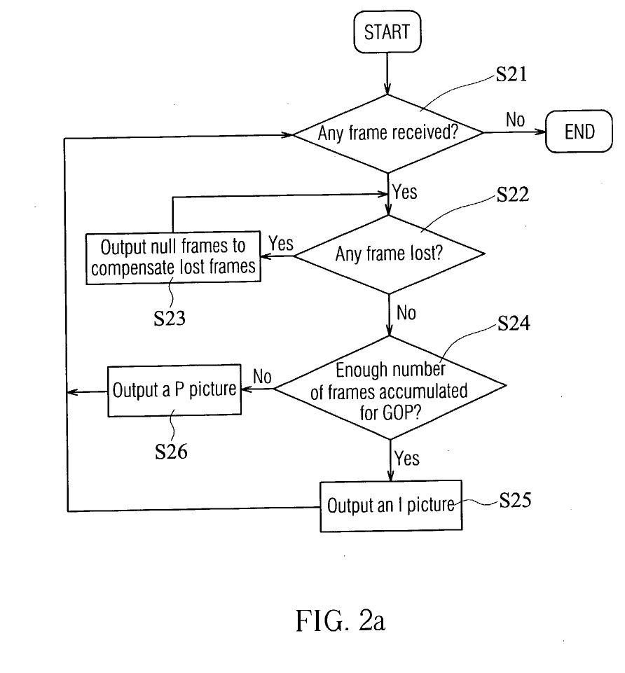

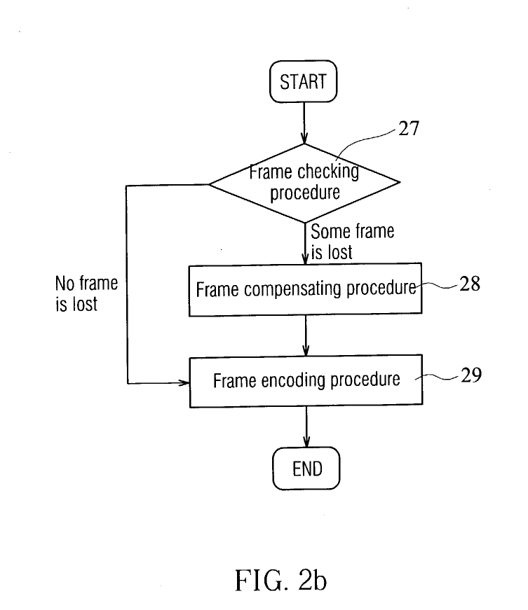

The real-time MPEG video encoding method of maintaining synchronization between video and audio in a preferred embodiment of the invention utilizes a forward prediction to generate P pictures with a predicted distance of 1. That is, for each of the P pictures, the reference frame is a previous frame. Referring to FIG. 2a, when frames are transmitted from a video source (S21), check whether there are any lost frames (S22). Reasons for causing lost frames could be that the system performance for MPEG video encoding does not meet the requirement, an insufficient number of frames are transmitted from the video source initially, or transmission quality is poor. The number of lost frames may be determined by comparing the current number of encoded frames with timestamps or frame sequence numbers provided by the input frames.

For instance, 30 frames are played in one second for NTSC. That is, 30 frames are transmitted to the system in one second for video encoding. Assuming that a video is 1 second in length. Each of the frames transmitted is sequentially assigned with one of frame sequence numbers from 1 to 30. Also, the system performs the video encoding to each of the 30 frames transmitted in sequence. Normally, an input frame with a sequence number of 25 implies that the system should have encoded 24 frames and is performing the video encoding for the 25^{th} frame. However, as a result of the insufficient system performance or poor transmission quality, the number of frames encoded by system may be only 20 when a sequence number of an input frame is 25. Obviously, some frames are lost. The number of lost frames Fₗₒₛₜ can be calculated using the following equation:

Fₗₒₛₜ=Fᵢₙₚᵤₜ−F_{coded}−1 (1)

Here, Fᵢₙₚᵤₜ is a number of frames being currently input, F_{coded} is a number of frames having been encoded by the system. Accordingly, the number of lost frames in the above example is 4. Similarly, by using timestamps, the sequence number of the corresponding frame can also be determined. For the above example, the time difference between two timestamps of two adjacent frames is about 1/30 second. If a first frame with a frame sequence number of 1 is indicated by a timestamp, the frame sequence numbers of the following frames can be determined from the corresponding timestamps divided by a time difference of 1/30 second. Then, the number of lost frames can be calculated by using the equation (1).

If a loss of frames is determined (S22), a step S23 is performed for outputting null frames to completely compensate the lost frames (the encoding of the null frames will be explained later). After the compensation of the lost frames, a video encoding of the input frames begins. A step S24 determines whether the GOP has accumulated an enough number of frames. Since a GOP consists of at least one I picture and a plurality number of P pictures which can be substituted by null frames, the input frames are encoded and output as an I picture when the GOP has accumulated enough number of frames (S25) for generating a new GOP; otherwise, a certain number of P pictures are output (S26) so that the current GOP can accumulate an enough number of frames. Both of the video encoding methods for the I and P pictures are conventional and will not be explained any further. Thereafter, the processing flow returns to the step S21 to check whether other frames are input. If no frames have been input, the whole process for video encoding is terminated.

In order to better understand the spirit of the invention, refer to FIG. 2b for the following detailed description. When frames are received from the video source, a frame checking procedure 27 is performed to check if the number of frames received is the same as the number of frames encoded. That is to check if there is a loss of frames. If any lost frames are detected, a procedure 28 is performed to compensate the lost frames by using null frames. After all of the lost frames are compensated, a frame-encoding procedure 29 is performed to encode the received frames with a standard MPEG video encoding procedure and then output the encoded frames. In the situation where no frame is lost, the frame-encoding procedure 29 is directly performed to encode and output the received frames.

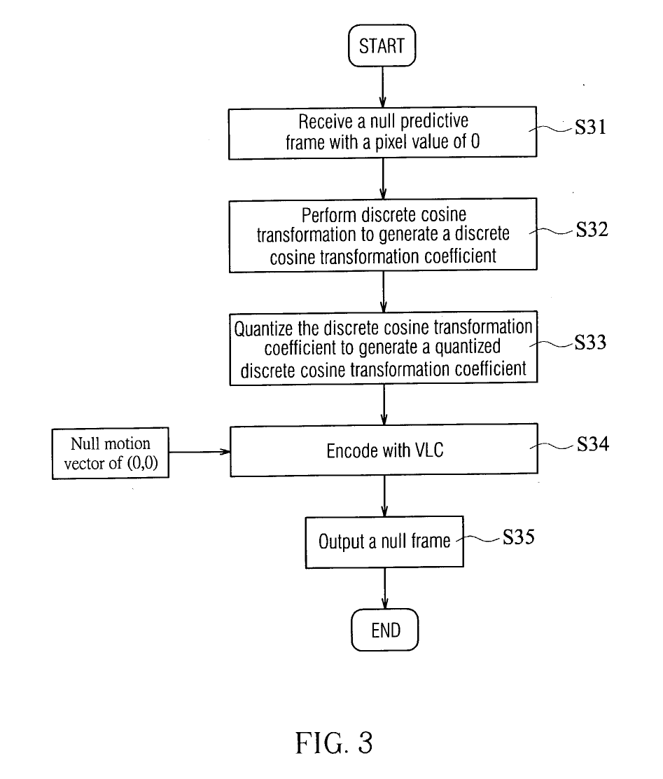

Now referring to FIG. 3, the encoding method for null frames is described. At first, a null predictive frame 31 with a pixel value of 0 is received (S31). The null predictive frame is transformed to a discrete cosine transform coefficient 32 by a discrete cosine transform algorithm (S32). The discrete cosine transform coefficient 32 is then transformed into a quantized discrete cosine transform coefficient 33 by quantization (S33). The quantized discrete cosine transform coefficient 33 is encoded with a null motion vector by variable length coding (VLC) (S34) to output a null frame (S35). The value of the null motion vector is (0,0). Because the motion estimation is omitted for the null frames and the calculation for the transformation and quantization of the discrete cosine are faster, the speed for encoding the null frames is considerably faster than those for the I, P, and B pictures.

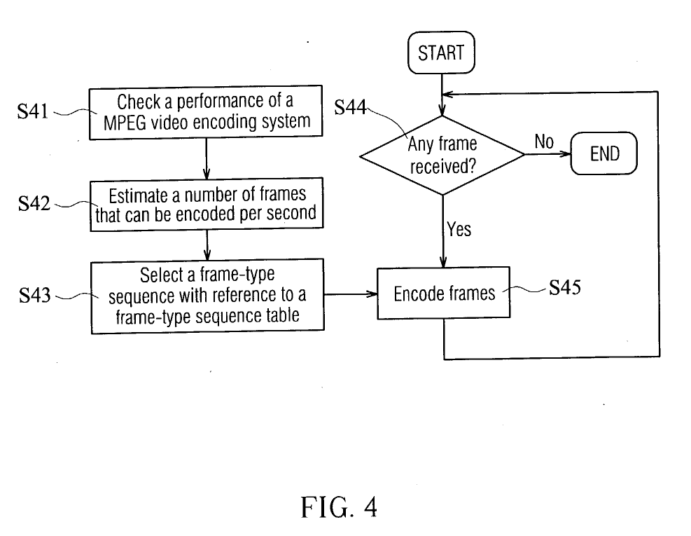

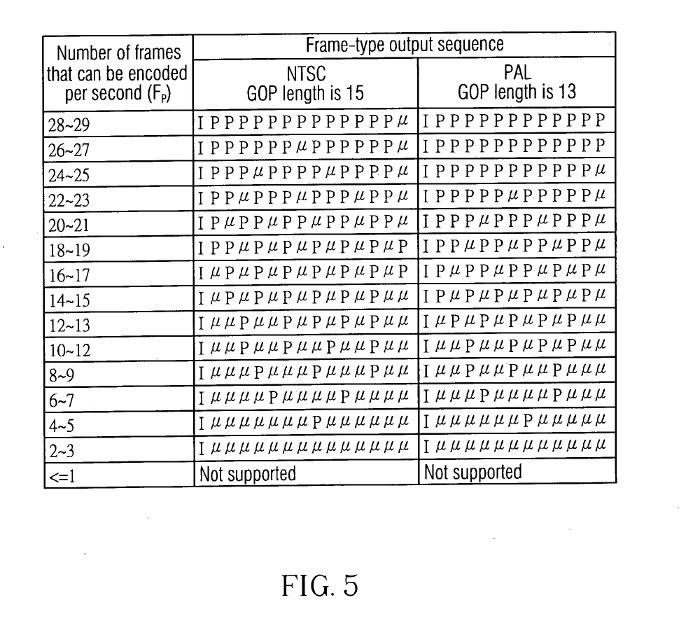

Another embodiment of the real-time MPEG video encoding method of maintaining synchronization between video and audio is described with reference to FIG. 4. First, a system performance for video encoding of a MPEG video encoding system 41 is detected (S41), and according to the performance evaluation of system 41, a number of frames that the system 41 can encode and output in one second is estimated (S42) and is denoted by Fₚ. Then, depending on the number Fp of frames that can be encoded per second, a suitable sequence for the output frame is selected with reference to a frame-type output sequence table (S43). The frame-type output sequence table is a predefined on the basis of experiment results. The content of the table refers to the frame-type output sequences of the frames included in each GOP. The types of frame include the I picture, the P picture, and the null frame. As shown in FIG. 5, for example, when the number Fₚ of frames encoded per second by a system is 20 to 21, the frame-type output sequence is IPμPPμPPμPPμPPμ for NTSC in each GOP with a length of 15 frames. For PAL, the frame-type output sequence is IPPμPPμPPμPPμ in each GOP with a length of 13 frames. Here, the symbol μ represents an intra-picture, the symbol P represents a predicted picture, and the symbol μ represents a null frame.

After a suitable sequence is selected for the output frames, when frames are received from the video source (S44), the MPEG video encoding is performed in accordance with the corresponding frame-type output sequence of the output frame sequence (S45). Continued from the above-mentioned example, for NTSC, the video is encoded in accordance with the frame-type output sequence IPμPPμPPμPPμPPμ. That is, a GOP consists of an I picture as a first frame, a P picture as a second frame, a null frame as a third frame, a P picture as a fourth frame, a P picture as a fifth frame, a null frame as a sixth frame, and so on. In this way, the video encoding procedure is repeated until no more input of frames. The I and P pictures are encoded by a conventional MPEG video encoding technique. The method for encoding null frames is as described above. It should be noted that the sequence of output frames listed in FIG. 5 is for illustration only A person skilled in the art can base on experiment results or any special requirements to set appropriate sequences for output frames. Besides, a length of a GOP may also be modified according to the demands such as requirements of video quality.

In accordance with embodiments of the invention, the process for motion estimation is omitted for null frames and the calculation for the transformation and quantization of the discrete cosine is faster, so the speed for encoding a null frame is much faster than those for the I, P, and B pictures. Therefore, when the real-time MPEG video encoding is performed, if a loss of frames is determined, some null frames can quickly be used to compensate the lost frames. Or, when the system performance of video encoding is insufficient, an output frame-type output sequence can be defined beforehand, so the null frames can be used by the system to compensate those frames which cannot be encoded in real-time, thereby reaching the number of frames required of maintaining synchronization between video and audio for an encoded MPEG file.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A real-time Motion Picture Experts Group (MPEG) video encoding method of maintaining synchronization between video and audio, comprising:
a frame checking procedure for determining whether a number of received frames is the same as a number of encoded frames;
a frame compensating procedure for using a null frame to compensate a lost frame when the number of frames encoded is less than the number of frames received; and
a frame encoding procedure for encoding a received frame with a standard procedure of MPEG video encoding and then outputting an encoded frame.

2. The method according to claim 1, wherein said encoded frame has two frame types of an intra picture (I picture) and a predicted picture (P picture), in which the P picture is generated by a forward prediction with a prediction distance of 1.

3. The method according to claim 1, wherein said number of received frames is a current frame sequence number provided by a received frame.

4. The method according to claim 1, wherein said number of received frames is a current frame sequence number calculated from a timestamp provided by a received frame.

5. The method according to claim 3, wherein a number of lost frames is calculated by using the following equation:
Fₗₒₛₜ=Fᵢₙₚᵤₜ−F_{coded}−1
wherein Fₗₒₛₜ is said number of lost frames, Fᵢₙₚᵤₜ is said sequence number of the current frame, F_{coded} is said number of encoded frames.

6. The method according to claim 1, wherein said null frame is encoded by the steps of:
receiving a null predictive frame;
generating a discrete cosine transform coefficient by using a discrete cosine transformation;
quantizing said discrete cosine transform coefficient to generate a quantized discrete cosine transform coefficient; and
encoding said quantized discrete cosine transform coefficient and a null motion vector by a variable length coding so as to output said null frame.

7. The method according to claim 6, wherein said null predictive frame has a pixel value of 0.

8. The method according to claim 6, wherein said null motion vector is (0,0).

9. A real-time MPEG video encoding method of maintaining synchronization between video and audio, comprising:
a system performance checking procedure for estimating a performance of a system and predicting a number of frames that can be encoded per second by the system;
a frame-type output sequence selecting procedure for selecting an frame-type output sequence for a plurality number of frames included in a group of pictures (GOP) in accordance with said number of frames that can be encoded per second with reference to a frame-type output sequence table; and
a frame encoding procedure for performing an MPEG video encoding on received frames in accordance with one frame type corresponding to said frame-type output sequence.

10. The method according to claim 9, wherein said frame-type output sequence table is predefined in such a content at least including said number of frames that can be encoded per second and said frame-type output sequence.

11. The method according to claim 10, wherein said frame type includes an intra picture (I picture), a predicted picture (P picture), and a null frame.

12. The method according to claim 11, wherein said P picture is generated by using a forward prediction with a predicting distance of 1.

13. The method according to claim 11, wherein said null frame is encoded by the steps of:
receiving a null predictive frame;
generating a discrete cosine transform coefficient by using a discrete cosine transformation;
quantizing said discrete cosine transform coefficient to generate a quantized discrete cosine transform coefficient; and
encoding said quantized discrete cosine transform coefficient and a null motion vector by a variable length coding so as to output said null frame.

14. The method according to claim 13, wherein said null predictive frame has a pixel value of 0.

15. The method according to claim 13, wherein said null motion vector is (0,0).

16. A real-time video encoding method for null frames used in MPEG video encoding to compensate lost frames, said method comprising:
receiving a null predictive frame;
generating a discrete cosine transform coefficient by using a discrete cosine transformation;
quantizing said discrete cosine transform coefficient to generate a quantized discrete cosine transform coefficient; and
encoding said quantized discrete cosine transform coefficient and a null motion vector by a variable length coding so as to output said null frame.

17. The method according to claim 16, wherein said null predictive frame has a pixel value of 0.

18. The method according to claim 16, wherein said null motion vector is (0,0).

19. The method according to claim 16, wherein
said null predictive frame has a pixel value of 0; and
said null motion vector is (0,0).
